(19) United States
(12) Patent Application Publication
(10) Pub. No.: US 2020/0022789 A1
(43) Pub. Date: Jan. 23, 2020

(54) METHOD FOR OPTICAL RECORDING OF THE SURFACE GEOMETRY OF GUMS

(71) Applicant: a.tron3d GmbH, Klagenfurt am Woerthersee (AT)

(72) Inventor: Juergen JESENKO, Riegersdorf (AT)

(21) Appl. No.: 16/519,693

(22) Filed: Jul. 23, 2019

(30) Foreign Application Priority Data
Jul. 23, 2018 (EP) 18 184 951.4

(51) Int. Cl. A61C 9/00; G01B 11/24; A61C 8/00

(52) U.S. Cl. CPC A61C 9/0053; A61C 8/008; G01B 11/24

(57) ABSTRACT

In a method for optical recording of the surface geometry of gums, an object with known surface geometry, in particular a gingiva former, is located in the region of the gum to be recorded. A surface geometry of the region is recorded optically together with the object and the known surface geometry of the object is subtracted from the recorded surface geometry.

### BACKGROUND OF THE INVENTION

### Field of the Invention

The invention concerns a method for optical recording of the surface geometry of gums.

### Description of the Related Art

In digital dental implantology there occur various challenges and problems. The primary problem of recording the teeth is already solved through many non-invasive, especially optical, methods. Problems, however, arise with soft tissues, such as e.g. the gums, the tongue or the insides of the cheeks, and with surfaces that are not ‘visible’. Under ‘visible’ one understands that a surface is recordable by scanners that work on the basis of sensors and/or light sources that can record and/or emit light in the visible or near the visible spectrum. With soft parts there occurs first and foremost the problem that these are soft and thus deformable. It is, therefore, easily possible to obtain conflicting measurements, which leads to inaccurate 3D images. Invisible surfaces have to be supplemented from other sources, such as e.g. 3D radiology or the like.

A special case is presented by gums with a gingiva former and an implant. Here one has either the disadvantage that a part of the gum which is essential for further planning of the implantation is concealed by the gingiva former itself and therefore is invisible, or one has the disadvantage that the gum contracts after removal of the gingiva former and therefore precise measurements are not possible. Moreover, the gum tends to bleed immediately after removal of the gingiva former, which likewise renders measurements difficult before the gum can contract.

### SUMMARY OF THE INVENTION

The underlying task of the invention, therefore, is to overcome the disadvantages described above and to make available a possibility for optical recording of gums, in particular in the region of gingiva formers.

According to the invention this task is solved through a method with the features of claim 1.

In a method according to the invention, initially the region to be recorded of the gum in which an object with known surface geometry, in particular a gingiva former, is present is scanned. In principle, the use of gingiva formers for healing the gum in a particular desired form in preparation for implantations is known from dentistry and takes place independently from the method according to the invention. For the scanning it is not required for the whole object to be visible. It suffices if only one region of the object is recorded. Since the surface geometry of the object is known, the position of the complete surface of the object can be derived from the position of one region of the surface. Obviously, this holds good only in so far as the measured surface geometry can be correlated sufficiently unambiguously with the known surface geometry. To this end the object can exhibit markers, in particular asymmetrical markers, which simplify appropriate correlation.

It is assumed that the gum is located directly next to the object and that where the object is located no gum can be located. If one subtracts the known surface geometry of the object from the recorded surface geometry, one consequently obtains the surface of the gum in the region of the object. This applies in particular also for those regions of the gum that are not visible, for example because they are concealed by the object.

The subtraction can include various sub-steps, such as e.g. changing the orientation of planes, such that planes marked as outsides become marked as insides and vice versa.

In general, both the surface geometry before the subtraction and the surface geometry after the subtraction can be saved. Accordingly, pursuant to an advantageous embodiment of the invention, it is envisaged that the recorded and the computed surface geometry are stored and that both surface geometries are each visualised alternately.

In an advantageous further development of the invention, the alternating display is based on an input by a user and the alternation of the two displays takes place in real time.

Further advantageous embodiments of the invention are disclosed as well.

### BRIEF DESCRIPTION OF THE DRAWINGS

An advantageous embodiment example of the invention is described in more detail in reliance on the drawings. The figures show:

FIG. 1 a schematic representation of an exemplifying intraoral situation,

FIG. 2 a schematic representation of a recorded surface geometry,

FIG. 3 the surface geometry of FIG. 2 supplemented by a known surface geometry,

FIG. 4 a schematic representation of a recorded surface geometry processed as per a method according to the invention, and

FIG. 5 a further development of the invention in analogy with the representation of FIG. 1.

### DESCRIPTION OF THE PREFERRED EMBODIMENTS

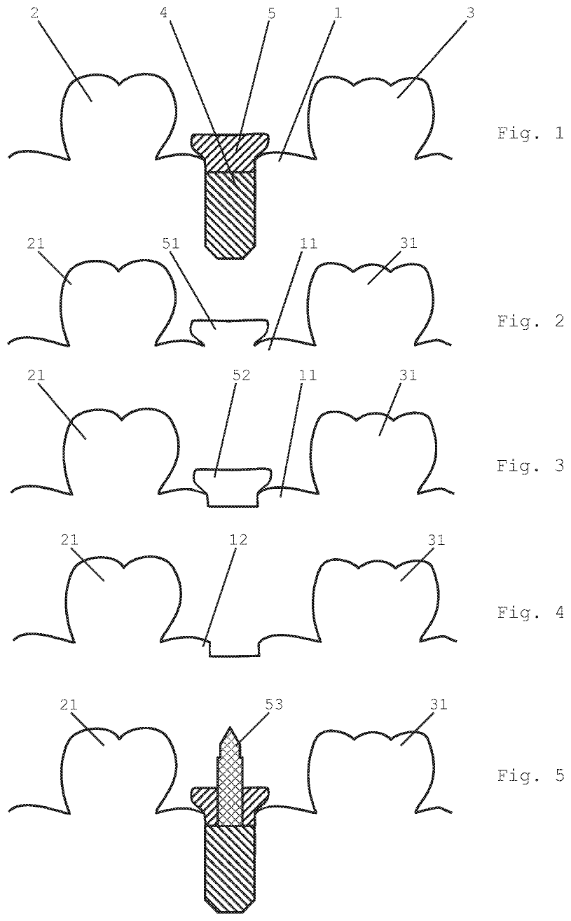

The exemplifying intraoral situation shown schematically in FIG. 1 exhibits two teeth 2, 3 arranged in the gum 1. Further there is present in the gum 1 and in the bone lying underneath it and not depicted for the sake of simplicity an implant 4. A gingiva former 5 is connected with the implant 4, for example via a threaded connector. The gingiva former 5 projects beyond the gum 1 and displaces the latter, such that it heals in a particular shape. The implant 4 had been implanted in the course of a regular dental treatment and although it is used for the invention's method, it was not implanted specifically for the invention's method. Analogously, the gingiva former 5 was also screwed in independently of the invention in the course of a regular treatment.

For the invention it is essential that the exact surface geometry of the object projecting from the gum 1 is known at least in part-regions. Whether this is a gingiva former 5 or another object with another purpose, is immaterial for the invention. According to a further development of the invention, an appropriate known surface geometry or a representative object with an appropriate known surface geometry is selected by a user, for example from a database.

FIG. 2 shows a surface geometry as it can be produced with an optical scanner from the intraoral situation depicted in FIG. 1. For the sake of a better view, all surface geometries in FIGS. 2 to 4 are depicted only as two-dimensional representations, even though in reality they are present as a three-dimensional representation. One recognises the surface geometries of the teeth 21, 31, the surface geometry of the gum 11 and the surface geometry of a part of the gingiva former 15. In accordance with the invention, the surface geometry of the part of the gingiva former 51 is identified. This can take place, for example, by attempting to fit a known surface geometry of the gingiva former 52 (see FIG. 3) into the recorded surface. For example, the well-known iterative closest point algorithm (ICP algorithm) can be used for this purpose.

During the course of the identification of the region of the recorded surface geometry, which shows a part of the surface geometry of the gingiva former 51, the spatial orientation of the gingiva former relative to the gum can be determined additionally.

FIG. 3 shows schematically the recorded surface geometry of FIG. 2 with the known surface geometry of the gingiva former 52 fitted into the recorded surface geometry. According to the invention, the known surface geometry of the gingiva former 52 is subtracted from the recorded surface geometry of the gum 11. This takes place in two steps, which can be carried in an arbitrary order one after the other or even simultaneously.

In one step, the visible portion of the known surface geometry of the gingiva former 52 is processed. This visible portion is removed completely from the recorded surface geometry.

In the other step, the invisible part of the known surface geometry of the gingiva former 52 is processed. This invisible portion of the known surface geometry of the gingiva former 52 is reversed, such that inner sides of the surface geometry become outer sides and vice versa, i.e. the orientation of the sides and/or areas is changed.

The precise method for the reversing of the surfaces depends on the labelling of the surface geometries. As an example but not limiting, the methods for surface geometries that are labelled as a signed distance function (SDF and TSDF) and as a polygonal mesh, are described in the following.

With signed distance functions it is indicated how far a surface is away in a viewing direction from a particular point within a voxel grid. The sign indicates whether in the viewing direction the point is located in front of or behind the surface and/or lies inside or outside. If the sign is reversed within a signed distance function, the orientation of the surface also changes and thus which side lies in the interior and which side in the exterior. Since in this type of surface reversing, especially few steps have to be performed and computationally it is especially simple and therefore also resource-conserving, the surface geometries are noted within a TSDF and preferably retain this notation also during the subtraction.

With polygonal notations the surface geometry consists of many (planar) polygons, usually triangles. The number of polygons used for a particular surface, therefore, determines how accurately the noted surface geometry can be approximated to a real surface. For each polygon, the vertices of the polygon are noted in space as well as a vector. The vector is normal to the plane of the polygon and its direction indicates which side of the polygon lies in the interior and which side lies in the exterior. If the inside and outside of a surface geometry are swapped around, therefore, it is necessary to invert the direction of the normal vectors of the polygons of the notation.

For the subtraction it is completely immaterial which of the two steps takes place first. If sufficient computational resources are available, both steps can also be performed simultaneously. In accordance with an advantageous further development of the invention, however, all steps take place in real time. This means that for the user essentially no perceptible time elapses between the start of the procedure and the display of the first visible and/or visualised results.

FIG. 4 shows the recorded surface geometry after the subtraction. A computed surface geometry of the gum 12 was formed from the reversed surface geometry of the invisible portions of the known surface geometry of the gingiva former.

In an advantageous further development of the invention, in a region surrounding the subtracted surface geometry an ambient colour of the computed surface geometry 12 is recorded and the computed surface geometry 12 is displayed in a colour corresponding to the recorded ambient colour. Put more simply, the artificially inserted surface geometry is so depicted that it corresponds to the colour of the surrounding gum 1. This makes the handling of a device operating in accordance with a method pursuant to the invention more natural and therefore more pleasant for the user.

In an advantageous further development that is also beneficial independently of the invention, the spatial position of the implant 4 can also be derived from the spatial position of the gingiva former 5. To this end it is only necessary to know how precisely implant 4 and gingiva former 5 are connected with each other. Since usually known threaded connectors are used which are tightened to a known and/or specified torque, it follows that the spatial position of the two objects can also be regarded as known. If there exist various possibilities for the surface geometry of the implant 4, they can also be selected from a database in analogy with the surface geometry of the gingiva former 5.

Since the position of teeth and bones relative to each other changes only very slowly and with active external influence, it can be assumed that as long as no orthodontic procedures have been carried out, the teeth are located in a constant spatial position relative to the bones in which they are embedded. It is envisaged that within the setting of the invention's method, i.e. the computation and/or derivation of the surface geometries of invisible regions from the recorded surface geometries of the visible regions of the object, no changes take place in the jaw, the teeth or other intraoral structures belonging to the human body.

If the position of the bones and the teeth relative to each other is known from an earlier time and with the gingiva former surrounding teeth are also recorded, the relative position of the implant in the bone can also be derived from the measured position of the gingiva former relative to the teeth and the computed position of the implant.

FIG. 5 shows a further development of the invention analogous to the depiction in FIG. 1. An addition 53 to the gingiva former 5 is detachably joined with the gingiva former 5, usually screwed into it. For this purpose the gingiva former can exhibit an appropriate mounting device, for example threaded connector. Such an addition can for example be a scan abutment known from the state of the art, or alternatively have only the surface properties of a scan abutment and beyond that be adapted for use in association with a gingiva former. With such an addition 53, the precise orientation and positioning of the gingiva former 5 in the gum 1 and in structures lying below it, such as e.g. bones, can be determined with greater reliability, which improves the overall quality of the method.

In a further advantageous embodiment of the invention, all the necessary computations are performed on the same computation unit. It is, therefore, not necessary after scanning to transfer the data to a specialised computer. As a result, handling a scanner operated with a method according to the invention is simplified and moreover is rendered more cost-effective.

### LIST OF DRAWINGS FOR REFERENCE

1 Gum
11 Recorded surface geometry of the gum
12 Computed surface geometry of the gum
2 Tooth
21 Recorded surface geometry of the tooth
3 Tooth
31 Recorded surface geometry of the tooth
4 Implant
5 Gingiva former
51 Recorded surface geometry of the gingiva former
52 Known surface geometry of the gingiva former
53 Addition to the gingiva former, exhibiting a known surface geometry

1. Method for optical recording of the surface geometry of gum (1), wherein an object (5) with known surface geometry (52), in particular a gingiva former, is located in the region of the gum to be recorded (11, 12), that a surface geometry (11, 21, 31, 51) of the region together with the object (5) is recorded optically and that the known surface geometry (52) of the object (5) is subtracted from the recorded surface geometry (51).

2. Method in accordance with claim 1, wherein the subtraction takes place in at least two steps.

3. Method in accordance with claim 2, wherein one of the subtraction steps includes the removal of the visible constituents of the object (5) with known surface geometry (52).

4. Method in accordance with claim 2, wherein one of the subtraction steps includes the production of a computed surface geometry (12) from the reversed invisible portions of the known surface geometry (52) and that the computed surface geometry (12) is inserted into the recorded surface geometry (11).

5. Method in accordance with claim 4, wherein an ambient colour of the subtracted surface geometry is recorded and that the computed surface geometry (12) is displayed in a colour corresponding to the recorded ambient colour.

6. Method in accordance with claim 1, wherein surface geometries of several different known objects are stored and a known surface geometry is selected for the method.

7. Method in accordance with claim 1, wherein all computational steps for recording and subtracting are performed on the same computation unit.

8. Method in accordance with claim 7, wherein the computational steps take place in real time.

9. Method in accordance with claim 1, wherein all surface geometries, in particular also during the subtraction, are labelled as TSDF.

10. Method in accordance with claim 1, wherein the object (5) has during the scanning a scanning aid (53), in particular a scan abutment, detachably joined with the object (5).

11. Method in accordance with claim 1, wherein the recorded and the computed surface geometry (11, 12) are stored and that both surface geometries are each visualised alternately.

12. Method in accordance with claim 11, wherein the alternate display is based on an input by a user and that the switching between the two displays takes place in real time.

13. Method in accordance with claim 11, wherein the display take place in real time during the switching.

14. Method in accordance with claim 3, wherein one of the subtraction steps includes the production of a computed surface geometry (12) from the reversed invisible portions of the known surface geometry (52) and that the computed surface geometry (12) is inserted into the recorded surface geometry (11).

15. Method in accordance with claim 2, wherein surface geometries of several different known objects are stored and a known surface geometry is selected for the method.

16. Method in accordance with claim 3, wherein surface geometries of several different known objects are stored and a known surface geometry is selected for the method.

17. Method in accordance with claim 4, wherein surface geometries of several different known objects are stored and a known surface geometry is selected for the method.

18. Method in accordance with claim 5, wherein surface geometries of several different known objects are stored and a known surface geometry is selected for the method.

19. Method in accordance with claim 2, wherein all computational steps for recording and subtracting are performed on the same computation unit.

20. Method in accordance with claim 3, wherein all computational steps for recording and subtracting are performed on the same computation unit.
